(19) United States
(12) Patent Application Publication
(10) Pub. No.: US 2014/0341014 A1
(43) Pub. Date: Nov. 20, 2014

(54) METHOD AND APPARATUS FOR UPDATING AN AREA IN A WIRELESS COMMUNICATION SYSTEM

(71) Applicant: LG ELECTRONICS INC., Seoul (KR)

(72) Inventors: Jaehyun Kim, Anyang-si (KR); Laeyoung Kim, Anyang-si (KR); Taehyeon Kim, Anyang-si (KR); Hyunsook Kim, Anyang-si (KR)

(21) Appl. No.: 14/344,312

(22) PCT Filed: Oct. 4, 2012
(86) PCT No.: PCT/KR2012/008022

§ 371 Date: Mar. 11, 2014

Related U.S. Application Data
(60) Provisional application No. 61/543,281, filed on Oct. 4, 2011.
(60) Provisional application No. 61/591,956, filed on Jan. 29, 2012.
(60) Provisional application No. 61/609,914, filed on Mar. 12, 2012.

(51) Int. Cl. H04L 12/801; H04W 68/02; H04W 4/00; H04L 29/08

(52) U.S. Cl. CPC H04L 47/12; H04L 67/12; H04L 47/14; H04W 68/02; H04W 4/005
USPC 370/229

(57) ABSTRACT

The present invention relates to a wireless communication system, and in particular, to a method and apparatus for updating an area in a wireless communication system. The method for updating an area by a terminal according to one embodiment of the present invention includes the steps of: starting a backoff timer set by a network; and transmitting an area-updating request message to the network when the terminal enters a new tracking area (TA) or a new routing area (RA) while the backoff timer is operating.

### TECHNICAL FIELD

The present invention relates to a wireless communication system and, more particularly, to a method and apparatus for updating an area of a terminal.

### BACKGROUND ART

Machine Type Communication (MTC) refers to a communication scheme between one or more machines and is also referred to as Machine-to-Machine (M2M) communication. In this case, a machine refers to an entity which does not require direct manipulation or intervention of a user. For example, not only a device including a mobile communication module, e.g., a meter or vending machine, but also a user equipment capable of performing communication by automatically accessing a network without manipulation or intervention of a user, e.g., a smartphone, may be machines. These machines are referred to as MTC devices or terminals in the present specification. That is, MTC refers to communication performed by one or more machines (i.e., MTC devices) without manipulation or intervention of a user.

MTC may include communication between MTC devices (e.g., Device-to-Device (D2D) communication) and communication between an MTC device and an MTC application server. Examples of communication between an MTC device and an MTC application server include communication between a vending machine and a server, communication between a Point of Sale (POS) device and a server, and communication between an electricity, gas, or water meter and a server. An MTC-based application may include, for example, security, transportation, and healthcare applications.

### DISCLOSURE

### Technical Problem

If congestion or overload occurs in a network, congestion control may be performed on the control plane. For example, network congestion control may be performed at a level of Non-Access Stratum (NAS) which is the uppermost stratum of the control plane between a terminal and a network control node on a wireless interface. In general, when network congestion occurs, a network may set a back-off timer for inhibiting a terminal from making a request to the network for a predetermined time.

According to the current definition for a wireless communication system, when a terminal moves to an unregistered location while a back-off timer is running in the terminal, the terminal may not update its location together with a network due to a restriction by the back-off timer. In this case, even when the network transmits a paging message to find the terminal, the paging message may not be received and thus the terminal may not perform a paging response procedure. Due to the failure of a paging procedure, the terminal may not receive a significant Mobile Terminated (MT) service (e.g., MT Call/Short Message Service (SMS)). As described above, ambiguity may exist in a network operation of a terminal related to network congestion control and an appropriate service may not be provided. In particular, in a wireless communication system supporting MTC, a network should provide service to a large number of terminals (or MTC devices) and thus ambiguity is not allowed in processing of network congestion.

An object of the present invention devised to solve the problem lies in a method and apparatus for allowing a terminal to appropriately perform a paging response procedure and receive a seamless service even when the terminal moves to an unregistered area.

It is to be understood that both the foregoing general description and the following detailed description of the present invention are exemplary and explanatory and are intended to provide further explanation of the invention as claimed.

### Technical Solution

The object of the present invention can be achieved by providing an area updating method of a terminal, the method including starting a back-off timer set by a network, and transmitting an area update request message to the network when the terminal enters a new Tracking Area (TA) or Routing Area (RA) while the back-off timer is running.

In another aspect of the present invention, provided herein is a terminal for updating an area, the terminal including a transceiver module for transmitting signals to and receiving signals from an external device, and a processor for controlling the terminal, wherein the processor is configured to start a back-off timer set by a network, and transmit an area update request message to the network using the transceiver module when the terminal enters a new Tracking Area (TA) or Routing Area (RA) while the back-off timer is running.

The followings may be commonly applied to the area updating method and the terminal.

The area update request message may be transmitted even if the back-off timer is running.

The area updating method may further include and the terminal may further perform stopping the back-off timer if the back-off timer is running when the terminal enters the new TA or RA.

The new TA or RA may be a TA or RA not listed on a TA or RA list previously registered by the terminal to the network.

The area update request message may include at least one of a Tracking Area Update (TAU) message and Routing Area Update (RAU) message.

The terminal may be accessed to an Evolved Packet System (EPS) service network.

The TAU message or RAU message may include at least one of a combined TAU message and combined RAU message.

The terminal may be accessed to both an EPS service network and non-EPS service network.

Idle mode Signaling Reduction (ISR) may be activated with respect to the terminal.

A value regarding the back-off timer may be included in a reject message when Non-Access Stratum (NAS) level congestion control is activated.

A value regarding the back-off timer may be provided from an Access Stratum (AS).

A value regarding the back-off timer may be randomly set within a range.

The back-off timer may be started based on the value regarding the back-off timer.

The back-off timer may be a Mobility Management (MM) back-off timer.

It is to be understood that both the foregoing general description and the following detailed description of the present invention are exemplary and explanatory and are intended to provide further explanation of the invention as claimed.

### Advantageous Effects

According to the present invention, a method and apparatus for allowing a terminal to appropriately perform a paging response procedure and receive a seamless service even when the terminal moves to an unregistered area may be provided.

It will be appreciated by persons skilled in the art that that the effects that could be achieved with the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a diagram schematically showing the architecture of an Evolved Packet Core (EPC);

FIG. 2 is a diagram showing exemplary Machine Type Communication (MTC) models;

FIG. 3 is a diagram showing exemplary MTC models;

FIG. 4 is a diagram showing the architecture of Tracking Area Identity (TAI);

FIG. 5 is a flowchart for describing an area update procedure of a terminal, according to an embodiment of the present invention;

FIG. 6 is a flowchart for describing an area update procedure of a terminal, according to another embodiment of the present invention;

FIG. 7 is a flowchart showing a Tracking Area Update (TAU) procedure according to an embodiment of the present invention;

FIG. 8 is a flowchart showing a Routing Area Update (RAU) procedure according to an embodiment of the present invention; and

FIG. 9 is a diagram showing the configuration of a terminal according to an embodiment of the present invention.

### BEST MODE

The following embodiments are proposed by combining constituent components and characteristics of the present invention according to a predetermined format. The individual constituent components or characteristics should be considered to be optional factors on the condition that there is no additional remark. If required, the individual constituent components or characteristics may not be combined with other components or characteristics. Also, some constituent components and/or characteristics may be combined to implement the embodiments of the present invention. The order of operations to be disclosed in the embodiments of the present invention may be changed to others. Some components or characteristics of any embodiment may also be included in other embodiments, or may be replaced with those of the other embodiments as necessary.

It should be noted that specific terms disclosed in the present invention are proposed for convenience of description and better understanding of the present invention, and the use of these specific terms may be changed to another format within the technical scope or spirit of the present invention.

In some instances, well-known structures and devices are omitted in order to avoid obscuring the concepts of the present invention and the important functions of the structures and devices are shown in block diagram form. The same reference numbers will be used throughout the drawings to refer to the same or like parts.

The embodiments of the present invention can be supported by the standard documents disclosed in any one of wireless access systems, such as an IEEE 802 system, a 3rd Generation Partnership Project (3GPP) system, a 3GPP Long Term Evolution (LTE) and LTE-A system, and a 3GPP2 system. That is, the steps or portions, which are not described in order to make the technical spirit of the present invention clear, may be supported by the above documents. In addition, all the terms disclosed in the present document may be described by the above standard documents.

The following technologies may be used in various wireless communication systems. For clarity, 3GPP LTE and 3GPP LTE-A will be focused upon in the following description, but the scope of the present invention is not limited thereto.

Terms used in the present specification are as follows.

UMTS (Universal Mobile Telecommunication System): Third generation mobile communication technology based on a Global System for Mobile Communication (GSM) developed by 3GPP.

EPS (Evolved Packet System): Network system including an Evolved Packet Core (EPC) which is a Packet Switched (PS) core network based on Internet Protocol (IP) and an access network such as LTE/UMTS Terrestrial Radio Access Network (UTRAN), which is evolved from UMTS.

NodeB: Base station of a GSM/Enhanced Data rates for Global Evolution (EDGE) Radio Access Network (GERAN)/UTRAN, which is mounted outdoors and coverage of which forms a macro cell.

eNodeB (eNB): Base station of an Evolved UTRAN (E-UTRAN), which is mounted outdoors and coverage of which forms a macro cell.

UE (User equipment): The UE may be referred to as a terminal, a Mobile Equipment (ME), a Mobile Station (MS), etc. In addition, the UE may be a portable device such as a laptop, a mobile phone, a Personal Digital Assistant (PDA), a smartphone, and a multimedia device or a non-portable device such as a vehicle mounted device. A UE or terminal may indicate an MTC device in MTC.

HNB (Home NodeB): Base station of a UMTS network, which is mounted indoors and coverage of which forms a micro cell.

HeNB (Home eNodeB): Base station of an EPS network, which is mounted indoors and coverage of which forms a micro cell.

Mobility Management Entity (MME): Network node of an EPS network, which performs a Mobility Management (MM) function and a Session Management (SM) function.

Packet Data Network-Gateway (PDN-GW)/PGW: Network node of an EPS network, which performs a UE IP address allocation function, a packet screening and filtering function and a charging data collection function.

Serving Gateway (SGW): Network node of an EPS network, which performs mobility anchor, packet routing, idle mode packet buffering, triggering for enabling an MME to page a UE.

Policy and Charging Rule Function (PCRF): Network node of an EPS network, which performs policy decision for dynamically applying Quality of Service (QoS) and charging policy differentiated per service flow.

Open Mobile Alliance Device Management (OMA DM): Protocol designed for management of mobile devices such as a mobile phone, a PDA or a portable computer, which performs functions such as device configuration, firmware upgrade, error report, etc.

Operation Administration and Maintenance (OAM): OAM is a set of network administration functions for providing network fault display, performance information, data and diagnostic functions.

Non-Access Stratum (NAS): Upper stratum of a control plane between a UE and an MME. This is a functional layer for signaling between a UE and a core network and exchanging a traffic message in an LTE/UMTS protocol stack, supports UE mobility, and supports a session management procedure for establishing and maintaining an IP connection between a UE and a PDN GW.

NAS configuration Management Object (NAS configuration MO): MO used to configure parameters related to NAS functionality with respect to a UE.

Selected IP Traffic Offload (SIPTO): Scheme for transmitting specific IP traffic through a public network such as the Internet instead of an operator network when transmitting the specific IP traffic through an H(e)NB or a macro cell. In a 3GPP release-10 system, an operator selects a PDN-GW which is physically close to a UE in an EPC network and supports handover of user traffic.

Packet Data Network (PDN): Network in which a server supporting a specific service (e.g., Multimedia Messaging Service (MMS) server, Wireless Application Protocol (WAP) server, etc.) is located.

PDN connection: Logical connection between a UE and a PDN, which is expressed by one IP address (one IPv4 address and/or one IPv6 prefix).

Access Point Name (APN): String indicating or identifying a PDN. A requested service or a network (PDN) is accessed through a PGW and the APN is the name (string) previously defined in the network in order to find the PGW. For example, the APN may be expressed by internet.mnc012.mcc345.gprs.

Machine Type Communications (MTC): Communication performed by a machine without human intervention.

MTC device: UE (e.g., vending machine, meter, etc.) which has a communication function through a core network and serves a specific purpose.

Service Capability Server (SCS): Server connected to a 3GPP network for communication with an MTC device using an MTC-InterWorking Function (IWF) and an MTC device located in a Home Public Land Mobile Network (HPLMN). The SCS provides capability for utilizing one or a plurality of applications.

MTC application: Service to which MTC is applied (e.g., remote metering, product movement tracking, etc.).

MTC application server: Server on a network in which an MTC application is executed.

MTC feature: Function of a network supporting an MTC application. For example, MTC monitoring is a feature for preparing for equipment loss in an MTC application such as remote metering and low mobility is a feature for an MTC application for an MTC device such as a vending machine.

Radio Access Network (RAN): Unit including a NodeB, an eNodeB and a Radio Network Controller (RNC) for controlling the NodeB and the eNodeB in a 3GPP network, which is present between UEs and provides connection to a core network.

Home Location Register (HLR)/Home Subscriber Server (HSS): Database having subscriber information in a 3GPP network. The HSS may perform functions such as configuration storage, identity management and user state storage.

Public Land Mobile Network (PLMN): Network configured for the purpose of providing a mobile communication service to individuals. This network may be configured on a per operator basis.

NAS level congestion control: Congestion or overload control function of an EPS network composed of APN based congestion control and general NAS level mobility management control.

Mobility Management (MM) back-off timer: Mobility Management back-off timer used to control congestion when congestion occurs in a network. While the MM back-off timer is running, a UE is set so as not to perform attach, location information update (e.g., Tracking Area Update (TAU)), Routing Area Update (RAU), service request/extended service request, etc. (in case of an emergency bearer service, a paging response in an existing region, or a Multimedia Priority Service (MPS), even if the MM back-off timer is running, the UE is set to make a request).

Session Management (SM) back-off timer: Session control back-off timer used to control congestion when congestion occurs in a network. While the SM back-off timer is running, a UE is set so as not to perform configure or change of a session based on an associated APN, etc. (in case of an emergency bearer service or an MPS, even if the SM back-off timer is running, the UE is set to make a request).

Tracking Area (TA): Registration area of a terminal in an EPS network. The TA is identified using a Tracking Area Identity (TAI).

Routing Area (RA): Registration area of a terminal for a packet core network domain in a General Packet Radio Service (GPRS)/UMTS network. The RA is identified using a Routing Area Identity (RAI).

Idle mode Signaling Reduction (ISR): Function for allowing an idle-mode terminal to move between an Evolved-UMTS Terrestrial Radio Access Network (E-UTRAN) and GERAN/UTRAN in registered RAs and TAs without performing TAU/RAU together with a core network (specifically, an MME or Serving GPRS Supporting Node (SGSN)).

Hereinafter, a description will be given based on the above-described terms.

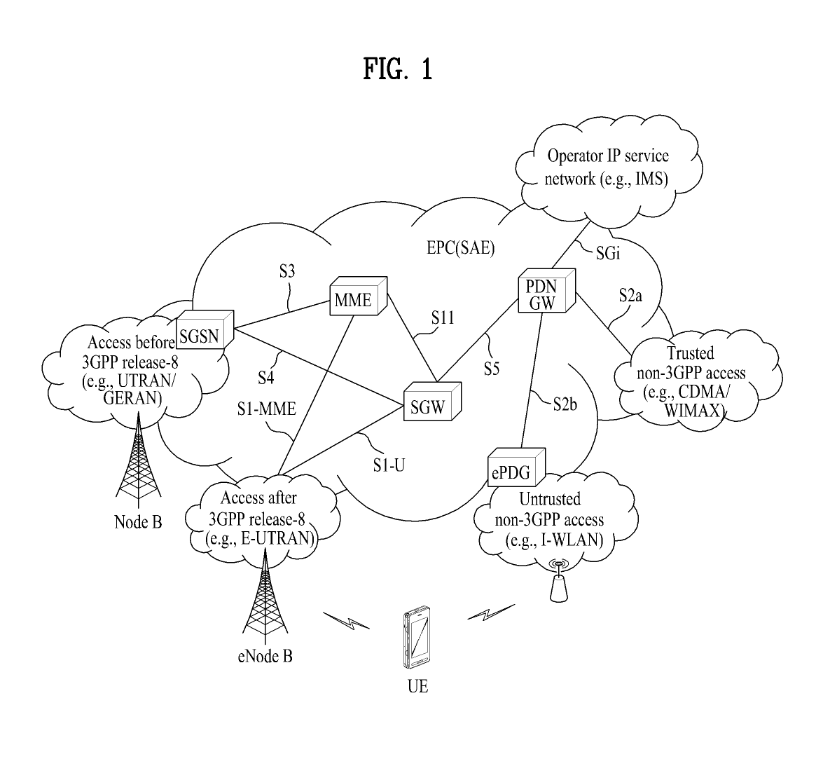

FIG. 1 is a diagram showing the schematic architecture of an Evolved Packet Core (EPC).

The EPC is a fundamental element of System Architecture Evolution (SAE) for improving 3GPP performance. SAE corresponds to a research project for deciding a network structure supporting mobility between various types of networks. SAE aims to provide an optimized packet-based system which supports various radio access technologies based on IP and provides improved data transfer capabilities.

More specifically, the EPC is a core network of an IP mobile communication system for a 3GPP LTE system and may support a packet-based real-time and non-real-time service. In the existing mobile communication system (i.e., a second or third generation mobile communication system), a core network function was implemented through two distinct sub-domains of a voice network (a Circuit-Switched (CS) network) and a data network (a Packet-Switched (PS) network). In a 3GPP LTE system which is evolved from the third generation communication system, sub-domains of a CS network and a PS network were unified into one IP domain. That is, in a 3GPP LTE system, a terminal having IP capability and a terminal may be connected through an IP based base station (e.g., eNodeB (evolved Node B)), an EPC, an application domain (e.g., IMS)). That is, the EPC is a structure necessary to implement an end-to-end IP service.

The EPC may include various components. FIG. 1 shows a Serving Gateway (SGW), a Packet Data Network Gateway (PDN GW), a Mobility Management Entity (MME), a Serving GPRS Supporting Node (SGSN) and an enhanced packet data gateway (ePDG).

The SGW operates as a boundary point between a Radio Access Network (RAN) and a core network and is an element which performs a function for maintaining a data path between an eNodeB and a PDG GW. In addition, if a terminal moves over a region served by an eNodeB, the SGW serves as a local mobility anchor point. That is, packets may be routed through the SGW for mobility in an Evolved UMTS Terrestrial Radio Access Network (E-UTRAN) defined after 3GPP release-8. In addition, the SGW may serve as an anchor point for mobility of another 3GPP network (an RAN defined before 3GPP release-8, e.g., UTRAN or GSM/EDGE Radio Access Network (GERAN).

The PDN GW corresponds to a termination point of a data interface for a packet data network. The PDN GW may support policy enforcement features, packet filtering and charging support. In addition, the PDN GW may serve as an anchor point for mobility management with a 3GPP network and a non-3GPP network (e.g., untrusted network such as an Interworking Wireless Local Area Network (I-WLAN) and a trusted network such as a Code Division Multiple Access (CDMA) or WiMax network).

Although the SGW and the PDN GW are configured as separate gateways in the example of the network structure of FIG. 1, the two gateways may be implemented according to a single gateway configuration option.

The MME performs signaling and control functions in order to support access to network connection of a UE, network resource allocation, tracking, paging, roaming and handover. The MME controls control plane functions related to subscriber and session management. The MME manages numerous eNodeBs and signaling for selection of a conventional gateway for handover to other 2G/3G networks. In addition, the MME performs security procedures, terminal-to-network session handling, idle terminal location management, etc.

The SGSN handles all packet data such as mobility management and authentication of a user for other 3GPP networks (e.g., GPRS networks).

The ePDG serves as a security node for a non-3GPP network (e.g., I-WLAN, Wi-Fi hotspot, etc.).

As described with reference to FIG. 1, a terminal having IP capabilities may access an IP service network (e.g., IMS) provided by an operator through various elements in the EPC based on 3GPP access or non-3GPP access.

FIG. 1 shows various reference points (e.g., S1-U, S1-MME, etc.). In the 3GPP system, a conceptual link connecting two functions present in different functional entities of an E-UTRAN and an EPC is defined as a reference point. Table 1 shows the reference points shown in FIG. 1. In addition to the example of Table 1, various reference points may be present according to network structure.

TABLE 1

| Reference | |
|---|---|
| point | Description |
| S1-MME | Reference point for the control plane protocol between |
| | E-UTRAN and MME |
| S1-U | Reference point between E-UTRAN and Serving GW for the |
| | per bearer user plane tunneling and inter eNodeB path |
| | switching during handover |
| S3 | It enables user and bearer information exchange for |
| | inter 3GPP access network mobility in idle and/or |
| | active state. This reference point can be used |
| | intra-PLMN or inter-PLMN (e.g. in the case of |
| | Inter-PLMN HO). |
| S4 | It provides related control and mobility support |
| | between GPRS Core and the 3GPP Anchor function of |
| | Serving GW. In addition, if Direct Tunnel is not |
| | established, it provides the user plane tunneling. |
| S5 | It provides user plane tunneling and tunnel management |
| | between Serving GW and PDN GW. It is used for Serving |
| | GW relocation due to UE mobility and if the Serving GW |
| | needs to connect to a non-collocated PDN GW for the |
| | required PDN connectivity. |
| S11 | Reference point between MME and SGW |
| SGi | It is the reference point between the PDN GW and the |
| | packet data network. Packet data network may be an |
| | operator external public or private packet data |
| | network or an intra operator packet data network, e.g. |
| | for provision of IMS services. This reference point |
| | corresponds to Gi for 3GPP accesses. |

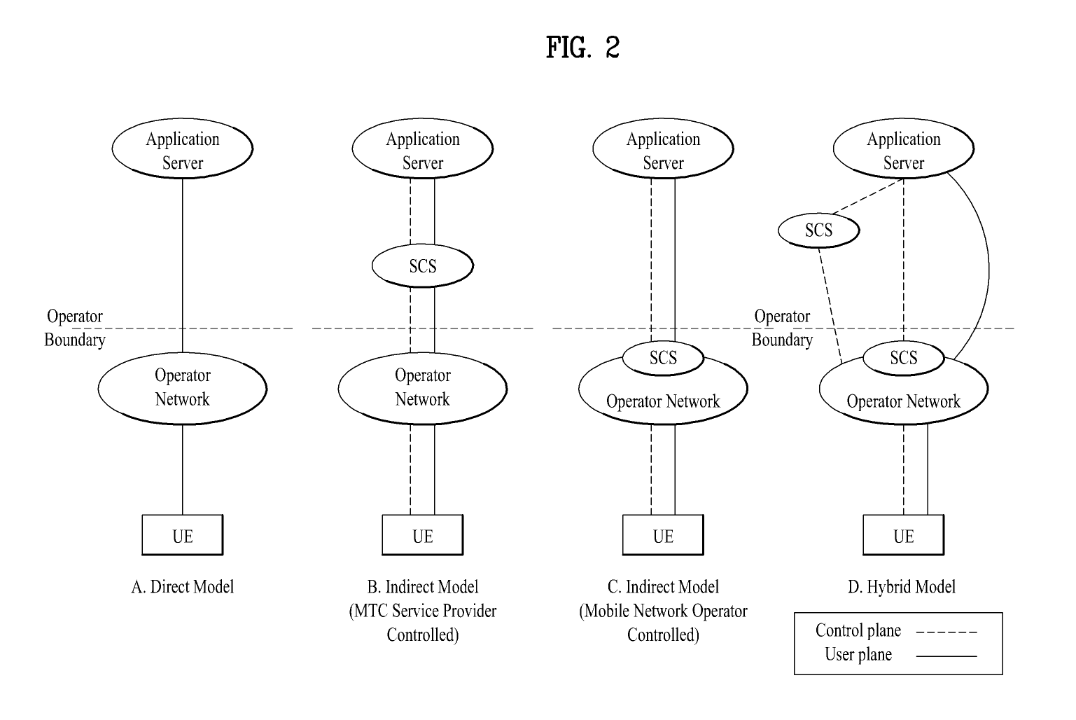

Among the reference points shown in FIG. 1, S2a and S2b correspond to a non-3GPP interface. S2a is a reference point for providing related control between the trusted non-3GPP access and the PDNGW and mobility support to a user plane. S2b is a reference point for providing related control between the ePDG and the PDNGW and mobility support to a user plane. FIG. 2 is a diagram showing exemplary Machine Type Communication (MTC) models.

The MTC application is executed in each of an MTC device and an SCS to interwork through communication using a network. At this time, various models of MTC traffic may be implemented depending on what participates in communication between an MTC application and a 3GPP network. FIG. 2(a) shows a model in which communication is directly performed without an SCS, FIG. 2(b) shows a model in which an SCS is located outside an operator domain, and FIG. 2(c) shows a model in which an SCS is located inside an operator domain. In addition, FIG. 2(a) corresponds to a direct communication scheme controlled by a 3GPP operator, FIG. 2(b) corresponds to a communication scheme controlled by a service provider, and FIG. 2(c) corresponds to a communication scheme controlled by a 3GPP operator.

The direct model of FIG. 2(a) shows that an MTC application directly performs communication with a UE (or an MTC device) with respect to a 3GPP network as an Over-the-Top (OTT) application.

The indirect model of FIGS. 2(b) and 2(c) shows that an MTC application indirectly performs communication with a UE (or an MTC device) using a supplementary service provided by a 3GPP network. More specifically, in the example of FIG. 2(b), the MTC application may use an SCS for supplementary services provided by a third-party (that is, for which 3GPP is not responsible) service provider. The SCS may perform communication with a 3GPP network through various interfaces. In the example of FIG. 2(c), the MTC application may use an SCS for supplementary services provided by a 3GPP operator (which corresponds to a service provider). Communication between an SCS and a 3GPP network is performed within a PLMN. In FIGS. 2(b) and 2(c), an interface between an SCS and an MTC application is not included in the 3GPP standard.

Since the indirect models of FIGS. 2(a) and 2(b) are complementary, a 3GPP operator may combine the indirect models for a different application. That is, as shown in FIG. 2(d), an MTC communication module may be implemented as a hybrid model in which a direct model and an indirect model are simultaneously used. In case of the hybrid model, the MTC device may perform communication with a plurality of SCSs in an HPLMN and an SCS controlled by a service provider and an SCS controlled by a 3GPP operator may be different in terms of capabilities provided to an MTC application.

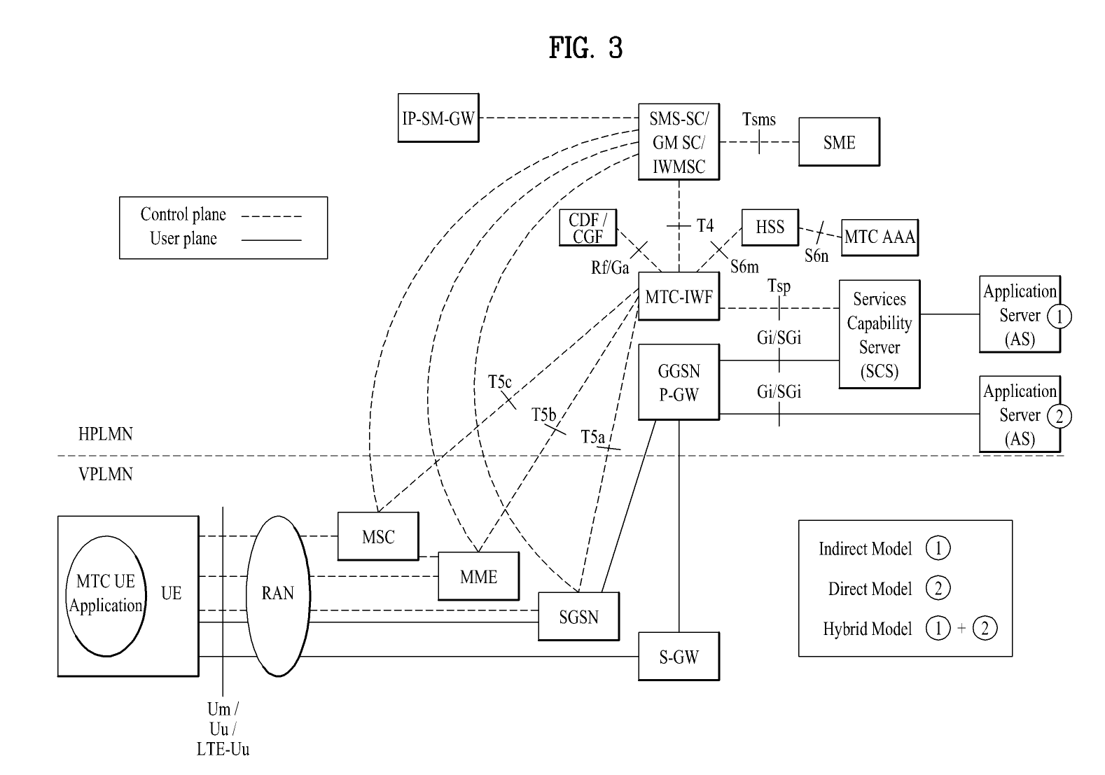

FIG. 3 is a diagram showing exemplary MTC models.

An end-to-end application between a UE (or MTC device) used for MTC and an MTC application may use services provided by a 3GPP system and selective services provided by an SCS. A 3GPP system may provide transport and communication services (including a 3GPP bearer service, and IMS and an SMS) including a variety of optimization services facilitating MTC. In FIG. 3, a UE used for MTC is connected to a 3GPP network (UTRAN, E-UTRAN, GERAN, I-WLAN, etc.) through a Um/Uu/LTE-Uu interface. The architecture of FIG. 3 includes various MTC models described with reference to FIG. 2.

First, entities shown in FIG. 3 will be described.

In FIG. 3, an MTC application may be executed by an application server on an external network and use an SCS for an additional service. Technologies for implementing various MTC applications are applicable to an MTC application server and a detailed description thereof will be omitted. In addition, the MTC application server may access an SCS through a reference point API and a detailed description thereof will be omitted. Alternatively, the MTC application server may be co-located with an SCS.

An SCS is a server on a network for managing an MTC device and may be connected to a 3GPP network to communicate with nodes of a PLMN and a UE used for MTC.

An MTC-InterWorking Function (IWF) may control interworking between an SCS and an operator core network and serve as a proxy of MTC operation. In order to support an MTC indirect or hybrid model, one or more MTC-IWFs may be present in a Home PLMN (HPLMN). The MTC-IWF may relay and interpret a signaling protocol on a reference point Tsp to enable a PLMN to perform a specific function. The MTC-IWF may perform a function for authenticating an MTC server, a function for authenticating a control plane request from an MTC server, various functions related to the below-described trigger instructions, etc. before the MTC server establishes communication with a 3GPP network.

A Short Message Service-Service Center (SMS-SC)/Internet Protocol Short Message Gateway (IP-SM-GW) may manage transmission and reception of an SMS. The SMS-SC serves to relay a short message between a Short Message Entity (SME) (an entity for transmitting or receiving a short message) and a mobile station and storing and forwarding the short message. The IP-SM-GW may serve to perform protocol interworking between an IP based UE and an SMS-SC.

A Charging Data Function (CDF)/Charging Gateway Function (CGF) may perform a charging operation.

HLR/HSS serves to store and provide subscriber information (International Mobile Station Ddentity (IMSI), etc.), routing information, configuration information, etc. to the MTC-IWF.

A SGSN/MME may perform a control function such as mobility management, authentication, resource allocation, etc. for network connection of a UE. In association with the below-described triggering, the SGSN/MME may serve to receive a trigger instruction from the MTC-IWF and process the trigger instruction into the form of a message provided to the MTC device.

A gateway GPRS Support Node (GGSN)/Serving-Gateway (S-GW)+Packet Data Network-Gateway (P-GW) may serve as a gateway for connecting a core network and an external network.

Table 2 shows main reference points of FIG. 3.

TABLE 2

| Reference | |
|---|---|
| Point | Description |
| Tsms | It is the reference point an entity outside the 3GPP system |
| | uses to communicate with UEs used for MTC via SMS. |
| Tsp | Reference point used by a SCS to communicate with the |
| | MTC-IWF related control plane signalling. |
| T4 | Reference point used by MTC-IWF to route device trigger to |
| | the SMS-SC in the HPLMN. |
| T5a | Reference point used between MTC-IWF and serving SGSN. |
| T5b | Reference point used between MTC-IWF and serving MME. |
| T5c | Reference point used between MTC-IWF and serving MSC. |
| S6m | Reference point used by MTC-IWF to interrrogate HSS/HLR |
| | for E.164 MSISDN or external identifier mapping to IMSI and |
| | gather UE reachability and configuration information. |
| S6n | Reference point used by MTC-AAA to interrogate HSS/HLR. |

In case of the indirect and hybrid model, user plane communication with an SCS may be performed and, in case of the direct and hybrid model, communication with an MTC application server may be performed using a conventional protocol through Gi and SGi. In addition, in the 3GPP standard, various schemes for implementing MTC, for example, a scheme for adjusting a paging range for an MTC application having low mobility, are suggested. However, communication between MTC devices (e.g., D2D communication) is not defined in the current 3GPP standard. As such, although an MTC procedure between an SCS and MTC device is mainly described below, the scope of the present invention is not limited thereto. That is, the principal of the present invention is equally applicable to MTC between MTC devices. Furthermore, although communication through a PS network is defined in relation to MTC in 3GPP GSM/UMTS/EPS as described above, such a communication scheme is merely exemplary. That is, the present invention is not limited to MTC through a PS network and is also applicable to MTC through a CS network.

Details related to description of FIGS. 2 and 3 may be incorporated by referring to 3GPP TS 23.682.

NAS Level Congestion Control

In general, the case in which a network exceeds a limit of a controllable communication amount may be referred to as a network congestion or overload state and operation for controlling a transmission/reception amount of a network to prevent network congestion may be referred to as network congestion control. In a 3GPP MTC network, if network congestion or overload occurs, NAS level congestion control is performed between a UE and a node (e.g., MME, SGW, PDN-GW, Mobile Switching Center (MSC), SGSN or GGSN) of a core network and thus signaling congestion may be avoided or controlled.

Such NAS level congestion control includes AP based congestion control and general NAS level management control.

APN based congestion control refers to signaling congestion control according to a Mobility Management (MM)/Session Management (SM) protocol associated with an APN (i.e., an APN associated with a congestion state) and a UE or an EPS Mobility Management (EMM)/EPS Session Management (ESM) protocol. APN based congestion control includes APN based session management congestion control and APN based mobility management congestion control.

General NAS level mobility management control means a code network node (e.g., MME, SGW, PDN-GW, MSC, SGSN or GGSN) rejects a mobility management signaling request made by a UE in a state of network congestion or overload to avoid congestion and overload.

In general, if a core network performs NAS level congestion control, a reject message provided to a UE may include a standby time (or an extended standby time) value. Such a standby time value is randomized within a predetermined range to be provided to the UE. The UE sets the received standby time value as a back-off timer value and operates so as not to request (E)MM/(E)SM signaling from a network until the back-off timer has expired.

(E)MM signaling includes, for example, an attach request, a TAU/RAU request, etc. In addition, (E)SM signaling includes, for example, PDN connectivity, bearer resource allocation, bearer modification, Packet Data Protocol (PDP) context activation, PDP context modification request, etc. The back-off timer may be divided into an MM back-off timer for control of (E)MM signaling and an SM back-off timer for control of (E)SM signaling. The MM back-off timer is assigned per UE and the SM back-off timer is assigned per associated APN or per UE. These timers may independently run.

Even if the back-off timer is running, an emergency service must be provided. Accordingly, if a UE has already performed or starts to perform an emergency bearer service with respect to service users having a high priority, it is possible to make a request for the service even if the MM/SM back-off timer is running. Service users having a high priority may access a network with Multimedia Priority Service access classes 11 to 15, for example.

TAU/RAU of Idle-Mode UE

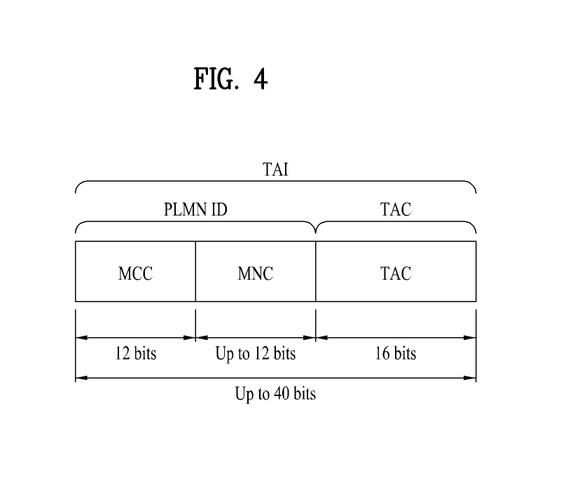

In the LTE network, a TA is a unit for UE registration and a unit used by an MME to check the location of an idle-mode UE. FIG. 4 is a diagram showing the architecture of a TAI. The TAI is an identifier (ID) of a TA. The TAI is configured in combination with a PLMN ID and a Tracking Area Code (TAC), and is an ID for globally and uniquely identifying the TA. The PLMN ID includes a Mobile Country Code (MCC) allocated by each country, and a Mobile Network Code (MNC) allocated by each operator. The TAC is an ID for identifying the TA in an operator network.

When a UE is accessed to the LTE network, UE registration is performed by an MME. The MME tracks the location of a UE registered to the MME, and should transmit data directed toward the UE, to the UE if the data occurs. If a UE is connected to a network, the MME knows a cell in which the UE is located. However, if the UE is in an idle mode and not connected to a network, the MME may not check the location of the UE on a cell basis. Accordingly, when the UE moves out of an existing registration area, the UE should report its new registration area to the MME. When the UE is in an idle mode, the MME may find the UE in a registration area most recently reported by the UE.

The registration area may be defined on a TA basis. The TA is a unit including one or more cells or BSs, and larger than a cell. When a TA in which the UE is located is changed, the UE should report a new TA to the MME, and thus the MME updates the location of the UE. If data directed toward the UE occurs when the UE is in an idle mode, the MME informs the UE about the data to be received by the UE, by transmitting a paging message to all BSs belonging to the most recently reported TA. If a TA size is large, since paging is performed by a large number of BSs, the UE can be found in a short time but signaling overhead due to the paging is increased. As such, the TA size needs to be appropriately configured. That is, the TA size is one of parameters for network optimization.

Basically, the MME allocates a TAI list to the UE when the UE is registered to a network. The TAI list is a list of one or more TAs. The UE does not make a TAU request when it moves from a current TA to a TA listed on the TAI list. However, if the UE moves to a TA not listed on its current TAI list (i.e., a TAI list recently registered to the MME), or if a TAU period has passed (that is, if a TAU timer is expired), the UE may transmit a TAU request to the MME. The MME may allocate a different TAI list to each UE according to a TAI allocation policy.

An RAU procedure defined for a GERAN/UMTS is similar to the above-described TAU procedure. Specifically, an RA corresponds to a registration area for a PS domain in the GERAN/UMTS. The RA is a unit for MS registration and a unit used by an SGSN to check the location of an idle-mode MS, and may be identified using an RAI. The RAI includes an MCC, MNC, Location Area Code (LAC), and Routing Area Code (RAC).

When the RA is changed, the MS should inform the SGSN about its location by reporting a new RA and the SGSN updates the location of the MS. If data directed toward the MS occurs when the MS is in an idle mode, the SGSN informs the MS about the data to be received by the MS, by transmitting a paging message to all BSs belonging to the most recently reported RA.

Basically, the SGSN allocates an RAI list to the MS when the MS is registered to a network. The RAI list is a list of one or more RAs.

The MS does not make an RAU request when it moves from a current RA to an RA listed on the RAI list. However, if the MS moves to an RA not listed on its current RAI list (i.e., an RAI list recently registered to the SGSN), or if an RAU period has passed (that is, if an RAU timer is expired), the MS may transmit an RAU request to the SGSN. The SGSN may allocate a different RAI list to each MS according to an RAI allocation policy.

ISR refers to a function for allowing an idle-mode terminal to move between an E-UTRAN and GERAN/UTRAN in registered RAs and TAs without performing TAU/RAU together with a core network (specifically, an MME or SGSN). When ISR is activated, as long as a UE/MS does not move out of TA(s)/RA(s) registered to a network, the UE/MS may reselect one of the E-UTRAN and GERAN/UTRAN without performing update on the network.

TAU/RAU performed by the UE/MS on both EPS service (i.e., PS domain service) and non-EPS service (i.e., CS domain service) networks is referred to as combined TAU/RAU.

Improved NAS Level Congestion Control

In general, a paging procedure is performed, for example, when a network or a network control node (e.g., MME or SGSN) requests a terminal (e.g., UE or MS) to configure NAS signaling connection, when a downlink (DL) data packet is present, when a Mobile Terminated (MT) call is generated, and when an SMS service is to be provided. That is, a network (e.g., MME or SGSN) may transmit a paging message to a terminal via a BS, and the terminal may make a paging response. The paging response may include an attach request, a service request, an extended service request, etc.

Exemplary cases when a network or a network control node (e.g., MME or SGSN) transmits a paging message to a terminal (e.g., UE or MS) are as follows.

i) A case when a NAS signal, CDMA2000 signaling message, or user data to be transmitted to a terminal exists. For example, a network may transmit a paging message using an SAE-Temporary Mobile Subscriber Identity (S-TMSI) or Paging-TMSI (P-TMSI) for an EPS service through an E-UTRAN.

ii) A case when IMSI attach is required for network error recovery. For example, a network may transmit a paging message using an IMSI for an EPS service through an E-UTRAN.

iii) A case when an MT call is received. For example, a network may transmit a paging message for CS fallback in an A/Gb or Iu mode. An A interface is used to connect a Circuit Switched Core Network (CSCN) and a Base Station System (BSS), and an interface corresponding to the A interface at a PS side is a Gb interface. The Iu mode is an interface defined to support a GERAN in addition to a UTRAN, and may be divided into two function parts, e.g., an Iu-PS interface for supporting a PS service and an Iu-CS interface for supporting a CS service.

iv) A case when an SMS is received. For example, a network may transmit a paging message when an SMS message regarding a terminal occurs.

In a normal network state (i.e., non-network congestion state), when cases i) to iv) occur, a paging message may reach a terminal known by the network, through BSs corresponding to a TA/RA of the terminal. In case i), a terminal transmits a service request message to the network (or network control node, e.g., MME or SGSN) as a response to the received paging message and performs a corresponding procedure. In case ii), a terminal performs an attach procedure (i.e., attach procedure using IMSI (Attach_With_IMSI)) as a response to the received paging message. In case iii), a terminal transmits an extended service request message to the network (or network control node, e.g., MME or SGSN) as a response to the received paging message and performs a corresponding procedure. In case iv), a procedure related to paging is performed according to cases i) and ii).

However, in a network congestion control state, if a paging procedure currently defined for a wireless communication system is performed as it is, the following problems may occur.

For example, in an MTC network congestion state, a network may set a back-off timer to a terminal using a NAS reject message. The NAC reject message may correspond to, for example, an attach reject, TAU reject, or service reject message. The terminal set with the back-off timer operates not to request related access or service until the back-off timer is expired (that is, while the back-off timer is running). For example, an MM back-off timer value may be provided from a network (e.g., MME, SGSN, or HSS) or transferred from a sub layer (e.g., Access Stratum (AS)), and is randomly set among basic values from 15 minutes to 30 minutes. If the MM back-off timer value is provided from the network, a corresponding back-off value is set by an operator according to a network state and policy. In general, the MM back-off timer value may be set to a few ten minutes to a few hours. That is, a terminal of which signaling to a network is rejected due to network congestion may perform signaling to the network after a few ten minutes to a few hours. As such, network congestion or overload caused by the terminal may be reduced or distributed, thereby achieving congestion control.

In addition, according to the current definition for a wireless communication system, when a paging message is transmitted to a terminal, the terminal may make a paging response even if a back-off timer is running (or by stopping the back-off timer). However, the terminal may not make a paging response in the following cases.

Initially, a paging response related to an MM back-off timer may have the following problems.

A first problem scenario relates to an EPS service. Here, it is assumed that a terminal is camping on an E-UTRAN/GERAN/UMTS and makes a TAU request/RAU request. In this case, if a network is congested, the terminal receives a TAU reject message/RAU reject message including an MM back-off timer from the network. After that, it is assumed that the terminal moves to a new TA/RA. The new TA/RA may be a TA/RA not registered to the network or a TA/RA not listed on a TAI list/RAI list of the terminal. In this case, since the MM back-off timer is still running, the terminal may not perform TAU/RAU. That is, the new TA/RA to which the terminal moves may not be recognized by the network. In this case, the network may transmit a paging message to find the terminal because, for example, a DL data packet directed toward the terminal occurs. The paging message is transmitted to the TA/RA known by the network (i.e., old TA/RA), and the terminal may not receive the paging message. As such, the terminal may not receive an EPS service.

Next, CS fallback may be considered. In an IP-based wireless communication system (e.g., LTE network), basically, even voice calls should be provided based on Voice over IP (VoIP). However, if VoIP is not fully provided, the voice call function should be provided by switching to a conventional CS network (e.g., 3G network). CS fallback refers to switching from an IP-based network to a conventional CS network as necessary.

A second problem scenario relates to CS fallback. It is assumed that a terminal is camping on an E-UTRAN/GERAN/UMTS, makes a TAU request/RAU request, but receives a reject message due to network congestion, and a back-off timer runs. After that, when the terminal moves to a new TA/RA, since the MM back-off timer is still running, the terminal may not perform TAU/RAU. In this case, if an MT call directed toward the terminal occurs and thus a paging procedure regarding CS fallback is initiated, a network transmits a paging message to a TA/RA recently known by the network (i.e., an old TA/RA from which the terminal moves), and the terminal may not receive the paging message. As such, the terminal may not receive the MT call.

A third problem scenario relates to an SMS. It is assumed that a terminal is camping on an E-UTRAN/GERAN/UMTS, makes a TAU request/RAU request, but receives a reject message due to network congestion, and a back-off timer runs. After that, when the terminal moves to a new TA/RA, since the MM back-off timer is still running, the terminal may not perform TAU/RAU. After that, if an SMS service regarding the terminal occurs, a network transmits a paging message to a TA/RA recently known by the network (i.e., an old TA/RA from which the terminal moves), and the terminal may not receive the paging message. As such, the terminal may not receive the SMS service.

As described above, when a terminal moves to a new TA/RA before an MM back-off timer is expired (that is, while the back-off timer is running after a reject message is received due to network congestion), according to the current definition for a wireless communication system, since the back-off timer is running, TAU/RAU may not be performed. As such, sine a network may not check the location of the terminal and may not successfully transmit a paging message to the terminal, due to influence of the MM back-off timer, the terminal (or user) may not receive a service for more than a few hours in the worst case.

In order to solve this problem, TAU/RAU should be processed while the back-off timer is running. Specifically, in order to provide a DL data packet, MT call, SMS service, etc. to a terminal, when the terminal moves to a new TA or RA which is not registered, the terminal may be configured to perform TAU or RAU even while the MM back-off timer is running. As such, a paging message regarding the terminal may appropriately reach the terminal and thus the terminal may perform a paging response procedure.

A description will now given of various embodiments of the present invention in which a terminal may perform TAU/RAU while a back-off timer set to the terminal due to, for example, network congestion is running.

### Embodiment 1

The current embodiment relates to a case when a terminal is accessed to an EPS service (or PS domain) network. That is, it is assumed that the terminal is attached to a network only for an EPS service.

In order to allow the terminal to appropriately make a paging response to an MT call or SMS service, when the terminal moves to a new TA or RA, which is not registered, while an MM back-off timer set to the terminal is running, the terminal may perform TAU or RAU even if the MM back-off timer is running.

Specifically, when it is detected that a UE/MS enters a TA (or RA) not listed on a TA list (or RA list) previously registered to an MME, the UE/MS performs TAU/RAU even if the MM back-off timer is running.

Since TAU/RAU is performed to the new TA/RA to which the terminal moves, a network may obtain information about the TA/RA where the terminal is actually located. Accordingly, a paging message transmitted from the network to the terminal thereafter may appropriately reach the terminal through a BS belonging to the TA/RA where the terminal is actually located. When the paging message is received, the terminal may make a paging response (e.g., service request or extended service request) by stopping the MM back-off timer.

The current embodiment corresponds to a scheme in which a terminal enters a new TA/RA and performs TAU/RAU by ignoring a back-off timer even if it is running. When a paging message is received thereafter, the terminal may make a paging response by stopping the back-off timer.

### Embodiment 2

The current embodiment relates to a case when a terminal is accessed to an EPS service (or PS domain) network. That is, it is assumed that the terminal is attached to a network only for an EPS service.

In order to allow the terminal to appropriately make a paging response to an MT call or SMS service, when the terminal moves to a new TA or RA, which is not registered, while an MM back-off timer set to the terminal is running, the terminal may perform TAU or RAU by stopping the MM back-off timer if it is running.

Specifically, when it is detected that a UE/MS enters a TA (or RA) not listed on a TA list (or RA list) previously registered to an MME, the UE/MS performs TAU/RAU by stopping the MM back-off timer if it is running.

Since TAU/RAU is performed to the new TA/RA to which the terminal moves, a network may obtain information about the TA/RA where the terminal is actually located. Accordingly, a paging message transmitted from the network to the terminal thereafter may appropriately reach the terminal through a BS belonging to the TA/RA where the terminal is actually located. When the paging message is received, the terminal may immediately make a paging response (e.g., service request or extended service request). In this case, since the back-off timer is not running when the terminal receives the paging message, the terminal may immediately make a paging response without performing an additionally procedure for stopping the back-off timer.

The current embodiment corresponds to a scheme in which a terminal enters a new TA/RA and performs TAU/RAU by stopping a back-off timer if it is running. When a paging message is received thereafter, the terminal may make a paging response without performing a procedure related to the back-off timer.

### Embodiment 3

The current embodiment relates to a case when a terminal is accessed to both an EPS service (or PS domain) network and non-EPS service (or CS domain) network. That is, it is assumed that the terminal is combined-attached for EPS and non-EPS services.

In order to allow the terminal to appropriately make a paging response to an MT call or SMS service, when the terminal moves to a new TA or RA, which is not registered, while an MM back-off timer set to the terminal is running, the terminal may perform combined TAU or combined RAU even if the MM back-off timer is running. Here, combined TAU/RAU refers to, as described above, TAU/RAU performed by the terminal on both EPS service (i.e., PS domain service) and non-EPS service (i.e., CS domain service) networks.

Specifically, when it is detected that a UE/MS enters a TA (or RA) not listed on a TA list (or RA list) previously registered to an MME, the UE/MS performs combined TAU/RAU even if the MM back-off timer is running.

Since combined TAU/RAU is performed to the new TA/RA to which the terminal moves, a network may obtain information about the TA/RA where the terminal is actually located. Accordingly, a paging message transmitted from the network to the terminal thereafter may appropriately reach the terminal through a BS belonging to the TA/RA where the terminal is actually located. When the paging message is received, the terminal may make a paging response (e.g., service request or extended service request) by stopping the MM back-off timer.

The current embodiment corresponds to a scheme in which a terminal enters a new TA/RA and performs combined TAU/RAU by ignoring a back-off timer even if it is running. When a paging message is received thereafter, the terminal may make a paging response by stopping the back-off timer.

### Embodiment 4

The current embodiment relates to a case when a terminal is accessed to both an EPS service (or PS domain) network and non-EPS service (or CS domain) network. That is, it is assumed that the terminal is combined-attached for EPS and non-EPS services.

In order to allow the terminal to appropriately make a paging response to an MT call or SMS service, when the terminal moves to a new TA or RA, which is not registered, while an MM back-off timer set to the terminal is running, the terminal may perform combined TAU or RAU by stopping the MM back-off timer if it is running.

Specifically, when it is detected that a UE/MS enters a TA (or RA) not listed on a TA list (or RA list) previously registered to an MME, the UE/MS performs combined TAU/RAU by stopping the MM back-off timer if it is running.

Since combined TAU/RAU is performed to the new TA/RA to which the terminal moves, a network may obtain information about the TA/RA where the terminal is actually located. Accordingly, a paging message transmitted from the network to the terminal thereafter may appropriately reach the terminal through a BS belonging to the TA/RA where the terminal is actually located. When the paging message is received, the terminal may immediately make a paging response (e.g., service request or extended service request). In this case, since the back-off timer is not running when the terminal receives the paging message, the terminal may immediately make a paging response without performing an additionally procedure for stopping the back-off timer.

The current embodiment corresponds to a scheme in which a terminal enters a new TA/RA and performs combined TAU/RAU by stopping a back-off timer if it is running. When a paging message is received thereafter, the terminal may make a paging response without performing a procedure related to the back-off timer.

### Embodiment 5

The current embodiment relates to TAU/RAU related to ISR.

As described above, when ISR is activated, as long as a terminal does not move out of TA(s)/RA(s) registered to a network, the terminal may reselect one of an E-UTRAN and GERAN/UTRAN without performing update on the network. In contrast, TAU/RAU should be performed when the terminal enters a new TA/RA not listed on a TA list/RA list registered to the network. However, TAU/RAU could not be appropriately performed when the terminal enters a new TA/RA while a back-off timer is running.

Accordingly, in the present invention, when ISR is activated, in order to allow the terminal to appropriately make a paging response to an MT call or SMS service, when the terminal moves to a new TA or RA, which is not registered, while an MM back-off timer set to the terminal is running, the terminal may perform TAU/RAU (or combined TAU/RAU) even if the MM back-off timer is running.

Alternatively, when ISR is activated, in order to allow the terminal to appropriately make a paging response to an MT call or SMS service, when the terminal moves to a new TA or RA, which is not registered, while an MM back-off timer set to the terminal is running, the terminal may perform TAU/RAU (or combined TAU/RAU) by stopping the MM back-off timer if it is running.

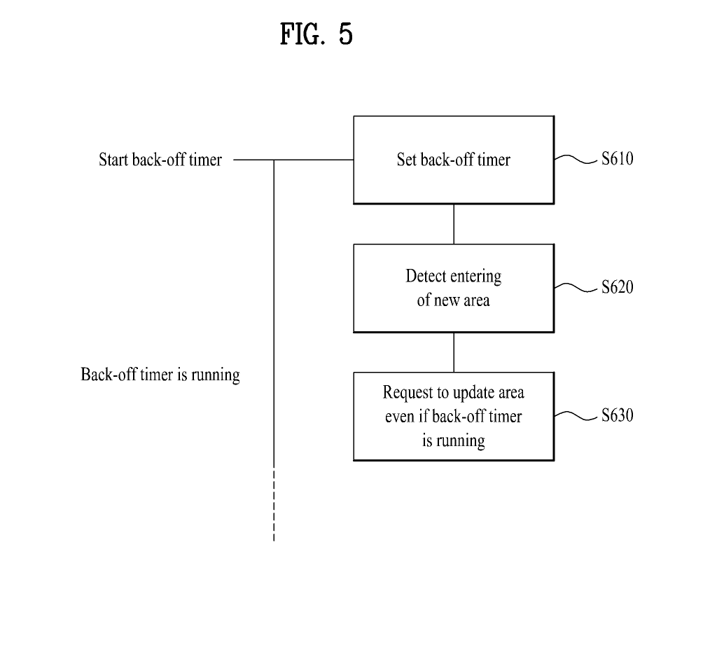

FIG. 5 is a flowchart for describing an area update procedure of a terminal, according to an embodiment of the present invention.

In step S610, the terminal may be set with a back-off timer by a network. As such, the terminal may start the back-off timer which runs for a determined time. Information about the setting of the back-off timer may be included in, for example, a NAS reject message, and the NAS reject message may be provided from a network control node to the terminal in, for example, a network congestion state. Here, the back-off timer may be an MM back-off timer.

In step S620, the terminal may detect that the terminal enters a new area while the back-off timer is running. Here, an area is a unit including the location of the terminal, and the new area refers to an area not registered to the network. For example, the area may correspond to a TA or RA related to the location of the terminal.

In step S630, even if the back-off timer is running, when the terminal detects that the terminal enters a new area in step S620, the terminal may transmit an area update request to the network. Here, the area update request may correspond to, for example, TAU, RAU, combined TAU, combined RAU, or location update.

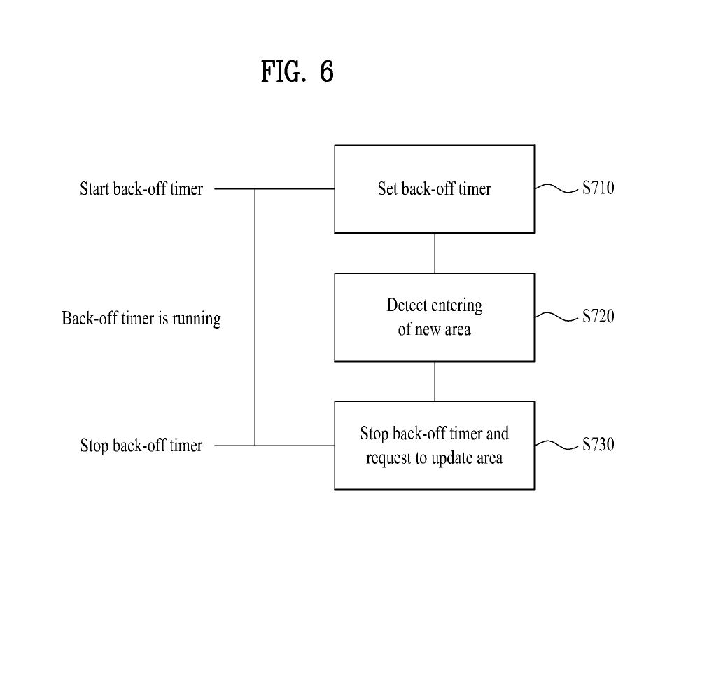

FIG. 6 is a flowchart for describing an area update procedure of a terminal, according to another embodiment of the present invention.

Steps S710 and S720 are respectively the same as steps S610 and S620 of FIG. 5 and thus repeated descriptions thereof are not provided here.

In step S730, when the terminal detects that the terminal enters a new area in step S720, if the back-off timer is running, the terminal may transmit an area update request (TAU/RAU, combined TAU/RAU, or location update) to the network by stopping the back-off timer.

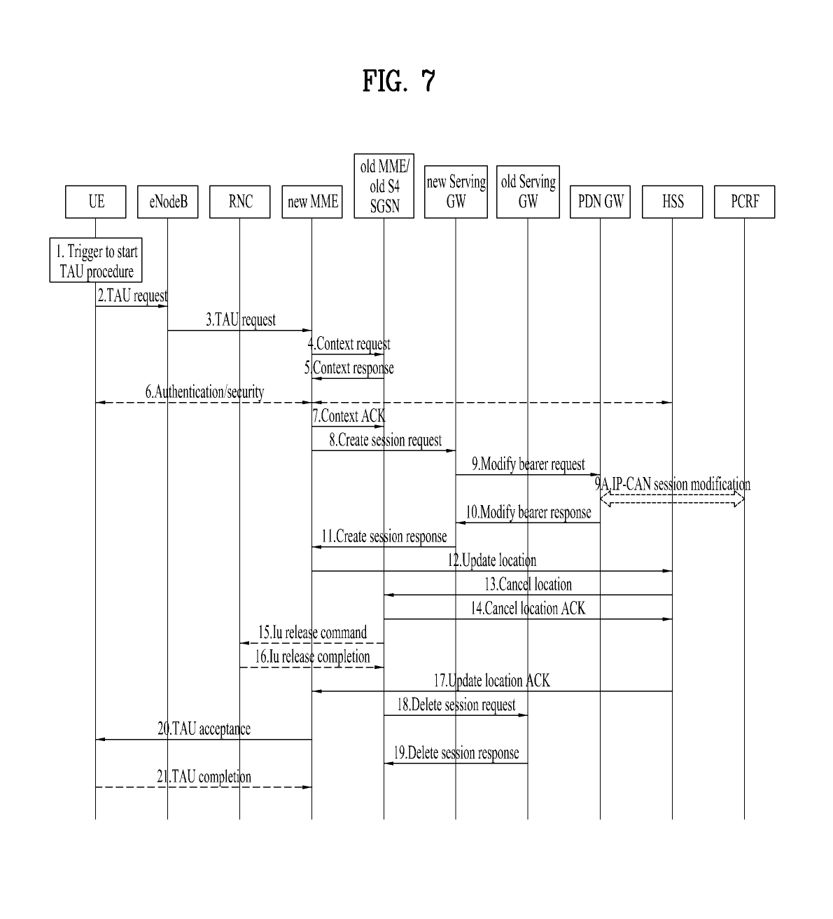

FIG. 7 is a flowchart showing a TAU procedure according to an embodiment of the present invention.

In step 1 of FIG. 7, a UE may trigger to start the TAU procedure. The triggering to start the TAU procedure may correspond to the step of determining to make the area update request even if the back-off timer is running or by stopping the back-off timer according to whether the back-off timer is running and whether the terminal moves to a new area in FIG. 5 or FIG. 6.

In steps 2 and 3 of FIG. 7, the UE may transmit a TAU request (or combined TAU request) through an eNB to a new MME. In FIG. 7, a new MME and SGW may be an MME and SGW related to a new location area of the UE, an old MME and SGW may be an MME and SGW related to an old location area of the UE.

In steps 4 and 5 of FIG. 7, the new MME may exchange a context request message and context response message with an old MME/SGGSN.

In step 6 of FIG. 7, information related to authentication and/or security may be exchanged between the UE and the new MME.

In step 7 of FIG. 7, the new MME may transmit a context ACK message indicating that context information is successfully received, to the old MME/SGSN.

In steps 8 to 11 of FIG. 7, the new MME may transmit a create session request message for creating a session, to a new SGW. The new SGW may transmit a modify bearer request message to a PGW based on information included in the create session request message. The PGW may transmit a modify bearer response message to the new SGW in response to the modify bearer request message, and the new SGW may transmit a create session response message to the new MME.

Step 9a of FIG. 7 is an optional procedure and PCRF interworking for an operator policy may be initiated due to a Policy and Charging Enforcement Function (PCEF) of the PGW and performed between the PCEF and PCRF as necessary. For example, session modification may be performed on an IP-Connectivity Access Network (CAN) which is an access network for providing IP connectivity. The IP-CAN is a term referring to a variety of IP-based access networks, for example, a 3GPP access network such as GPRS or EDGE, a WLAN, or a Digital Subscriber Line (DSL) network.

In steps 12 to 14 of FIG. 7, the new MME may provide updated location information of the UE to an HSS, and the HSS may store the same. The HSS may transmit a message for canceling the location information of the UE, to the old MME/SGSN, and thus the old MME/SGSN may cancel the location of the UE and transmit an ACK message thereof to the HSS.

In steps 15 to 16 of FIG. 7, the old MME/SGSN may transmit an Iu release command to an RNC, and the RNC may transmit an Iu release completion message to the old MME/SGSN.

In step 17 of FIG. 7, the HSS may transmit an ACK message regarding the updated location of the UE, to the new MME.

In step 18 of FIG. 7, the old MME/SGSN may transmit a delete session request message to an old SGW, and the old SGW may transmit a delete session response message to the old MME/SGSN.

In steps 20 to 21 of FIG. 7, the new MME may transmit a TAU acceptance message to the UE, and the UE may transmit a TAU completion message in response, thereby completing the TAU procedure.

As described above in relation to FIG. 7, even when a UE moves to a new area while a back-off timer is running, the UE may inform a network about its current location by performing TAU or combined TAU to the new area. As such, the network may appropriately transmit a paging message to the UE, and the UE may perform a paging response procedure (e.g., service request).

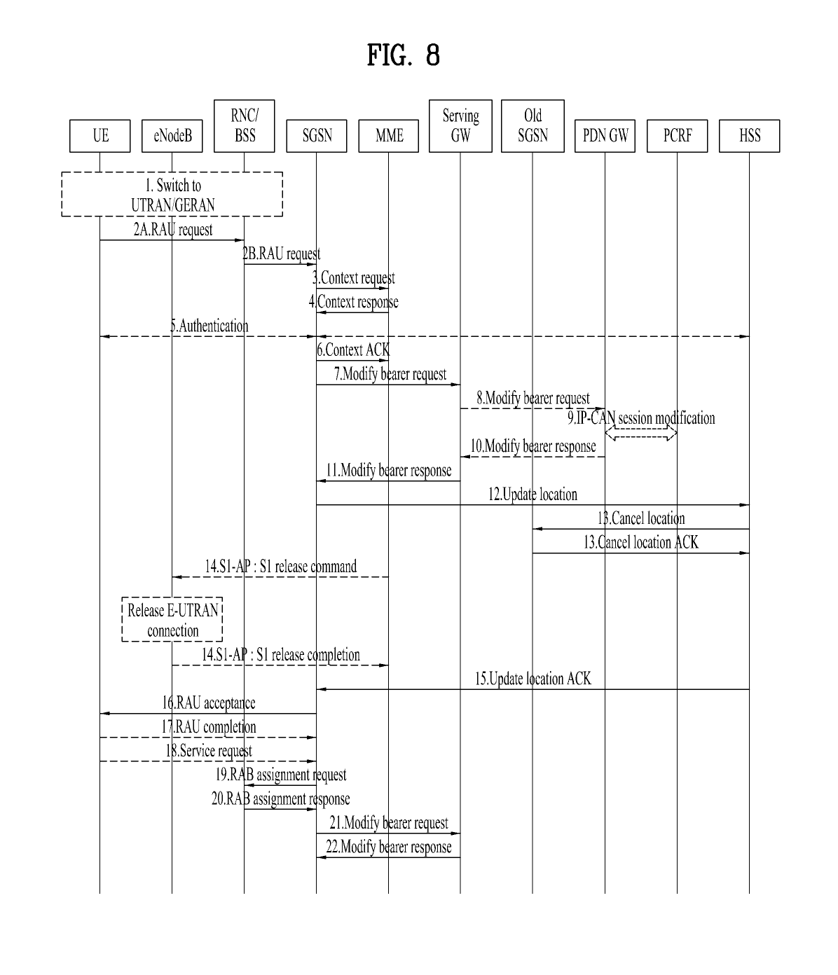

FIG. 8 is a flowchart showing an RAU procedure according to an embodiment of the present invention.

In step 1 of FIG. 8, it is assumed that a UE switches its operation mode from an E-UTRAN to a UTRAN/GERAN or moves to a UTRAN/GERAN system area. In addition, in step 1, the UE may trigger to start the RAU procedure. The triggering to start the RAU procedure may correspond to the step of determining to make the area update request even if the back-off timer is running or by stopping the back-off timer according to whether the back-off timer is running and whether the terminal moves to a new area in FIG. 5 or FIG. 6.

In steps 2a and 2b of FIG. 8, the UE may transmit an RAU request through an RNC/BSS to an SGSN.

Steps 3 to 7 of FIG. 8 correspond to steps 4 to 7 of FIG. 7. The old MME of FIG. 7 corresponds to an MME of FIG. 8, and the new MME of FIG. 7 corresponds to the SGSN of FIG. 8. As such, a new control node (SGSN) may obtain context information from an old control node (MME), and an authentication/security procedure between an HSS and the UE may be performed.

In steps 7 to 11 of FIG. 8, the SGSN may transmit a modify bearer request message through an SGW to a PGW for bearer configuration. The PGW may transmit a modify bearer response message through the SGW to the SGSN in response to the modify bearer request message. Step 9 is an optional procedure and a procedure related to IP-CAN session modification initiated by a PCEF may be performed as necessary.

In steps 12 to 14 of FIG. 8, the SGSN may provide updated location information of the UE to an HSS, and the HSS may store the same. The HSS may transmit a message for canceling the location information of the UE, to an old SGSN, and thus the old SGSN may cancel the location of the UE and transmit an ACK message thereof to the HSS.

In step 14 of FIG. 8, an S1 release procedure may be performed by an MME related to an old location of the UE and an eNB. The MME may transmit an S1 release command message to the eNB using an S1 Application Protocol (AP). As such, the eNB may release E-UTRAN connection and transmit an S1 release completion message to the MME.

In step 15 of FIG. 8, the HSS may transmit an ACK message regarding the updated location of the UE, to the SGSN.

In steps 16 and 17 of FIG. 8, the SGSN may transmit an RAU acceptance message to the UE, and the UE may transmit an RAU completion message in response, thereby completing the RAU procedure.

In step 18 of FIG. 8, the UE may transmit a service request message to the SGSN as necessary.

In steps 19 and 20 of FIG. 8, the SGSN may transmit a Radio Access Bearer (RAB) assignment request to an RNC/BSS, and the RNC/BSS may transmit an RAB assignment response message to the SGSN. In steps 21 and 22 of FIG. 8, the SGSN may transmit a modify bearer request message to the SGW, and the SGW may transmit a modify bearer response message to the SGSN. As such, an RAB regarding the UE may be assigned and a service may be provided.

As described above in relation to FIG. 8, even when a UE moves to a new area while a back-off timer is running, the UE may inform a network about its current location by performing RAU or combined RAU to the new area. As such, the network may appropriately transmit a paging message to the UE, and the UE may perform a paging response procedure (e.g., service request).

The above-described embodiments of the present invention may be applied independently or simultaneously in a combined manner.

In addition, although the above-described examples of the present invention are applied to a wireless communication service of an MTC scheme, the principle of the present invention is equally applicable to a location updating procedure of a terminal of a general wireless communication system.

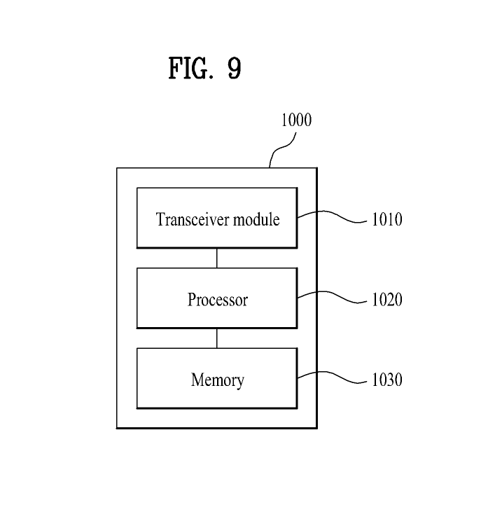

FIG. 9 is a diagram showing the configuration of a terminal 1000 according to an embodiment of the present invention.

Referring to FIG. 9, the terminal 1000 may include a transceiver module 1010, a processor 1020, and a memory 1030. The transceiver module 101 may be configured to transmit various signals, data, and information to and receive various signals, data, and information from an external device (e.g., network node, another terminal, server, etc.). The processor 1020 may provide overall control to the terminal 1000 and the terminal 1000 may be configured to perform a function for processing information transmitted to or received from the external device. The memory 1030 may store the processed information for a predetermined time and is replaceable by another element such as a buffer (not shown).

The terminal 1000 may be configured to update an area. The processor 1020 of the terminal 1000 may be configured to start a back-off timer set by a network. In addition, the processor 1020 may be configured to transmit an area update request message to the network using the transceiver module 1010 if the terminal 1000 enters a new area while the back-off timer is running.

The above-described embodiments of the present invention may be applied independently or simultaneously in a combined manner to the terminal 1000.

The embodiments of the present invention can be implemented by a variety of means, for example, hardware, firmware, software, or a combination thereof.

In the case of implementing the present invention by hardware, the present invention can be implemented with Application Specific Integrated Circuits (ASICs), Digital Signal Processors (DSPs), Digital Signal Processing Devices (DSPDs), Programmable Logic Devices (PLDs), Field Programmable Gate Arrays (FPGAs), a processor, a controller, a microcontroller, a microprocessor, etc.

If operations or functions of the present invention are implemented by firmware or software, the present invention can be implemented in the form of a variety of formats, for example, modules, procedures, functions, etc. Software code may be stored in a memory unit so that it can be driven by a processor. The memory unit is located inside or outside of the processor, so that it can communicate with the aforementioned processor via a variety of well-known parts.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may use each construction described in the above embodiments in combination with each other. Accordingly, the invention should not be limited to the specific embodiments described herein, but should be accorded the broadest scope consistent with the principles and novel features disclosed herein.

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with other claims referring to the other claims other than the specific claims to constitute the embodiment or add new claims by means of amendment after the application is filed.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The above-described embodiments of the present invention are applicable to a variety of mobile communication systems.

1. A method for area updating by a terminal, the method comprising:
starting a back-off timer set by a network; and
transmitting an area update request message to the network when the terminal enters a new Tracking Area (TA) or Routing Area (RA) while the back-off timer is running.

2. The method according to claim 1, wherein the area update request message is transmitted even if the back-off timer is running.

3. The method according to claim 1, further comprising stopping the back-off timer if the back-off timer is running when the terminal enters the new TA or RA.

4. The method according to claim 1, wherein the new TA or RA is a TA or RA not listed on a TA or RA list previously registered by the terminal to the network.

5. The method according to claim 1, wherein the area update request message comprises at least one of a Tracking Area Update (TAU) message and Routing Area Update (RAU) message.

6. The method according to claim 5, wherein the terminal is accessed to an Evolved Packet System (EPS) service network.

7. The method according to claim 1, wherein the TAU message or RAU message comprises at least one of a combined TAU message and combined RAU message.

8. The method according to claim 7, wherein the terminal is accessed to both an EPS service network and non-EPS service network.

9. The method according to claim 1, wherein Idle mode Signaling Reduction (ISR) is activated with respect to the terminal.

10. The method according to claim 1, wherein a value regarding the back-off timer is comprised in a reject message when Non-Access Stratum (NAS) level congestion control is activated.

11. The method according to claim 1, wherein a value regarding the back-off timer is provided from an Access Stratum (AS).

12. The method according to claim 1, wherein a value regarding the back-off timer is randomly set within a range.

13. The method according to claim 10, wherein the back-off timer is started based on the value regarding the back-off timer.

14. The method according to claim 1, wherein the back-off timer is a Mobility Management (MM) back-off timer.

15. A terminal for updating an area, the terminal comprising:
a transceiver module for transmitting signals to and receiving signals from an external device; and
a processor for controlling the terminal,
wherein the processor is configured to:
start a back-off timer set by a network; and
transmit an area update request message to the network using the transceiver module when the terminal enters a new Tracking Area (TA) or Routing Area (RA) while the back-off timer is running.

16. The method according to claim 11, wherein the back-off timer is started based on the value regarding the back-off timer.

17. The method according to claim 12, wherein the back-off timer is started based on the value regarding the back-off timer.
